(19) United States
(12) Patent Application Publication
(10) Pub. No.: US 2024/0392787 A1
(43) Pub. Date: Nov. 28, 2024

(54) INDUCERS FOR CRYOGENIC PUMPS AND RELATED SYSTEMS AND METHODS

(71) Applicant: DWC & ASSOCIATES, LLC, Lake Havasu City, AZ (US)

(72) Inventors: Dennis W. Chalmers, Lake Havasu City, AZ (US); Mina M. Botrous, Lake Havasu City, AZ (US); Christopher Finley, Lake Havasu City, AZ (US)

(21) Appl. No.: 18/674,232

(22) Filed: May 24, 2024

Related U.S. Application Data
(60) Provisional application No. 63/468,960, filed on May 25, 2023.

(51) Int. Cl. F04D 9/02; F04D 13/08; F04D 29/22

(52) U.S. Cl. CPC F04D 9/02; F04D 13/08; F04D 29/2277

(57) ABSTRACT

An inducer may include a hub having an outer lateral surface extending from a leading end to a trailing end, the outer lateral surface having a leading surface section having a first cylindrical shape, an intermediate surface section having a frustoconical shape, and a trailing surface section having a second cylindrical shape. The inducer may include main blades extending circumferentially along a first helical path over the leading surface section, the intermediate surface section, and the trailing surface section, the first helical path having an increasing helix angle. The inducer may additionally include splitter blades, each of the splitter blades located circumferentially between two of the main blades, respectively.

### CROSS REFERENCE TO RELATED APPLICATIONS

This application claims the benefit of the filing date of U.S. Provisional Patent Application Ser. No. 63/468,960, titled “MODULAR CRYOGENIC PERMANENT MAGNET ELECTRICAL MOTORS AND GENERATORS FOR SUBMERGED MOTOR PUMPS AND TURBINES AND RELATED SYSTEMS AND METHODS,” filed May 25, 2023, the disclosure of which is incorporated herein in its entirety by reference.

### TECHNICAL FIELD

The present disclosure relates generally to inducers for fluid handling devices, such as, for example, submerged motor cryogenic pumps. More particularly, embodiments of the present disclosure may relate to inducers for submerged motor cryogenic pumps that may be used in the liquefaction, transportation, and/or regasification of refrigerated methane liquid, liquefied natural gas, and/or related light hydrocarbon liquids, and/or other fluid and/or liquids, such as liquid hydrogen and/or liquid ammonia, and related systems and methods.

### BACKGROUND

Pumps may be utilized to control the flow of fluids in various hydraulic processes. For example, some pumps may be used to increase (e.g., boost) the pressure in a hydraulic system, while other pumps may be used to move the fluids from one location to another.

Such devices may be implemented in cryogenic applications including, for example, the liquefaction, transportation and regasification of refrigerated methane liquid, liquefied natural gas (LNG), and/or related light hydrocarbon liquids and other fluids, such as, for example, liquid hydrogen or liquid ammonia. For example, cryogenic submerged pumps may be used in the LNG supply industry where pumps are used to transfer the product from storage tanks to LNG carriers at the production plant, from the carriers to shore-side storage tanks, and then pumped at high pressure through vaporizers to pipelines. Such cryogenic submerged pumps may benefit from the use of inducers.

Inducers, also known as pre-swirl devices or booster pumps, are components used in certain types of centrifugal pumps to improve their performance, particularly in situations where low suction pressure conditions or cavitation may occur. In some situations, pumps may operate under conditions where the suction pressure is low, or there are limitations due to NPSH (Net Positive Suction Head). NPSH is the difference between the total suction head and the vapor pressure of the fluid, and, if it falls below a certain level, cavitation can occur. Cavitation is the formation and subsequent collapse of vapor bubbles in a liquid due to low pressure areas in the pump. When bubbles collapse, they create shock waves, leading to erosion of pump components and decreased pump efficiency. Cryogenic submerged motor pumps may be particularly susceptible to fluid vaporization and cavitation, which may result in pump failure and/or reduced pump performance.

Inducers are designed to address the challenges of low suction pressure conditions and cavitation. An inducer's blades may be angled to induce a rotational component to the incoming fluid flow and the inducer may increase the fluid pressure, helping to prevent cavitation by ensuring that the fluid pressure remains above the vapor pressure.

Existing inducers, however, may suffer from significant problems. For example, inertial forces during startup may cause existing inducers to fracture and break, which may cause debris to travel into the pump and cause pump failure. Additionally, fluid vaporization may still occur in some relatively low-pressure conditions (e.g., relatively low fluid levels). Existing inducers may not be able to accommodate such fluid vaporization, and vapor may be fed into a pump causing cavitation in the pump, reducing pump performance, and/or contributing to pump failure.

Additionally, it would be desirable to improve pumps with inducers to accommodate relatively low fluid level conditions in a tank and facilitate the removal of fluid in a tank to relatively low levels. Any fluid that a pump is unable to remove from a tank may reduce the effective size of the tank, which may reduce the productivity and/or profitability of a facility. Likewise, it would be desirable to improve the handling of two-phase fluids (i.e., mixed vapor and liquid fluids).

### BRIEF SUMMARY

In some aspects, the techniques described herein relate to inducers for cryogenic pumps. An inducer may include a hub, main blades, and splitter blades. The hub may have an outer lateral surface extending from a leading end to a trailing end, the outer lateral surface having a leading surface section having a first cylindrical shape, an intermediate surface section having a frustoconical shape, and a trailing surface section having a second cylindrical shape. The main blades may extend radially from the outer lateral surface of the hub to an outer diameter of the inducer and extend circumferentially along a first helical path over the leading surface section, the intermediate surface section, and the trailing surface section, the first helical path having an increasing helix angle from the leading surface section to the trailing surface section defining a main blade angle. The splitter blades may extend radially from the outer lateral surface of the hub to the outer diameter of the inducer and extend circumferentially along a second helical path starting on the intermediate surface section and extending over the intermediate surface section and the trailing surface section of the outer lateral surface of the hub, the second helical path having an increasing helix angle from the leading surface section to the trailing surface section defining a splitter blade angle, each of the splitter blades located circumferentially between two of the main blades, respectively.

In some aspects, the techniques described herein relate to an inducer, wherein a diameter of the trailing surface section of the hub is at least about 75% of the outer diameter of the inducer.

In some aspects, the techniques described herein relate to an inducer, wherein a diameter of the trailing surface section of the hub is about 78% of the outer diameter of the inducer.

In some aspects, the techniques described herein relate to an inducer, wherein a diameter of the leading surface section of the hub is less than about 33% of the outer diameter of the inducer.

In some aspects, the techniques described herein relate to an inducer, wherein a diameter of the leading surface section of the hub is about 30% of the outer diameter of the inducer.

In some aspects, the techniques described herein relate to an inducer, wherein each of the main blades have a swept leading edge defined by a gradually increasing radial blade length over a sweep angle of at least 40 degrees from a leading tip, located at the leading surface section of the hub, to a trailing end, located at the outer diameter of the inducer.

In some aspects, the techniques described herein relate to an inducer, wherein a leading edge of each splitter blade is at least about 30% closer to a circumferentially trailing main blade than a circumferentially leading main blade.

In some aspects, the techniques described herein relate to an inducer, wherein a trailing edge of each splitter blade is about equal distance from a circumferentially trailing main blade and a circumferentially leading main blade.

In some aspects, the techniques described herein relate to an inducer, wherein the leading surface section of the hub is greater than 5% of the axial length of the inducer and the trailing surface section of the hub is greater than 5% of the axial length of the inducer.

In some aspects, the techniques described herein relate to an inducer, wherein each of the main blades and each of the splitter blades include an arcuate outer lateral surface defining the outer diameter of the inducer.

In some aspects, the techniques described herein relate to an inducer, wherein the arcuate outer lateral surface of one or more of the main blades has a wrap angle of about 180 degrees.

In some aspects, the techniques described herein relate to an inducer, wherein the main blade angle at each location of one or more of the main blades at the outer diameter of the inducer is smaller than the main blade angle at the outer lateral surface surface of the hub corresponding to the same axial location.

In some aspects, the techniques described herein relate to an inducer, wherein the main blade angle of one or more of the main blades at the leading edge location at the outer lateral surface surface of the hub is less than about 25 degrees.

In some aspects, the techniques described herein relate to an inducer, wherein the main blade angle of one or more of the main blades at the trailing edge location at the outer lateral surface surface of the hub is greater than about 27 degrees.

In some aspects, the techniques described herein relate to an inducer, wherein the main blade angle of one or more of the main blades at the leading edge location at the outer diameter of the inducer is less than about 8.5 degrees.

In some aspects, the techniques described herein relate to an inducer, wherein the main blade angle of one or more of the main blades at the trailing edge location at the outer diameter of the inducer is greater than about 20 degrees.

In some aspects, the techniques described herein relate to pumps for pumping a cryogenic fluid. A pump may include a fluid inlet and a fluid outlet, a motor, a pump stage, an inducer located between the fluid inlet and the pump stage, and a drive shaft coupling the motor to the pump stage and the inducer. The inducer may include a hub, main blades, and splitter blades. The hub may have an outer lateral surface extending from a leading end to a trailing end, the outer lateral surface having a leading surface section having a first cylindrical shape, an intermediate surface section having a frustoconical shape, and a trailing surface section having a second cylindrical shape. The main blades may extend radially from the outer lateral surface of the hub to an outer diameter of the inducer and extend circumferentially along a first helical path over the leading surface section, the intermediate surface section, and the trailing surface section, the first helical path having an increasing helix angle from the leading surface section to the trailing surface section defining a main blade angle. The splitter blades may extend radially from the outer lateral surface of the hub to the outer diameter of the inducer and extend circumferentially along a second helical path starting on the intermediate surface section and extending over the intermediate surface section and the trailing surface section of the outer lateral surface of the hub, the second helical path having an increasing helix angle from the leading surface section to the trailing surface section defining a splitter blade angle, each of the splitter blades located circumferentially between two of the main blades, respectively.

In some aspects, the techniques described herein relate to a pump, further including an inducer guide vane located between the inducer and the pump stage.

In some aspects, the techniques described herein relate to a method of inducing flow into a cryogenic pump, the method including rotating an inducer to draw fluid through a fluid inlet with the inducer and direct the fluid into an inducer guide vane to provide fluid to a first pump stage of the cryogenic pump at a pressure greater than about 100 feet of head higher than at the fluid inlet and with greater than 3 degrees Kelvin subcooling relative to the fluid temperature at the fluid inlet.

In some aspects, the techniques described herein relate to a method, further including providing fluid to the first pump stage of the cryogenic pump at a pressure greater than about 125 feet of head higher than at the fluid inlet and with greater than 4 degrees Kelvin subcooling relative to the fluid temperature at the fluid inlet.

In some aspects, the techniques described herein relate to a method, further including providing fluid to the first pump stage of the cryogenic pump at a pressure greater than about 140 feet of head higher than at the fluid inlet and with greater than 5 degrees Kelvin subcooling relative to the fluid temperature at the fluid inlet.

In some aspects, the techniques described herein relate to a method, further including recondensing fluid having a vapor fraction over 18% at the inlet and delivering the fluid in a subcooled liquid state to the first pump stage.

In some aspects, the techniques described herein relate to methods of manufacturing cryogenic pumps. A method may include coupling a motor to a drive shaft, coupling a pump stage to the drive shaft, and coupling an inducer to the drive shaft. The inducer may include a hub, main blades, and splitter blades. The hub may have an outer lateral surface extending from a leading end to a trailing end, the outer lateral surface having a leading surface section having a first cylindrical shape, an intermediate surface section having a frustoconical shape, and a trailing surface section having a second cylindrical shape. The main blades may extend radially from the outer lateral surface of the hub to an outer diameter of the inducer and extend circumferentially along a first helical path over the leading surface section, the intermediate surface section, and the trailing surface section, the first helical path having an increasing helix angle from the leading surface section to the trailing surface section defining a main blade angle. The splitter blades may extend radially from the outer lateral surface of the hub to the outer diameter of the inducer and extend circumferentially along a second helical path starting on the intermediate surface section and extending over the intermediate surface section and the trailing surface section of the outer lateral surface of the hub, the second helical path having an increasing helix angle from the leading surface section to the trailing surface section defining a splitter blade angle, each of the splitter blades located circumferentially between two of the main blades, respectively.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments of the disclosure when read in conjunction with the accompanying drawings, in which:

FIG. 1 is an elevational cross-sectional view of a modular submerged motor cryogenic pump according to an embodiment of the present disclosure.

FIG. 2 is an isometric view of an inducer according to an embodiment of the present disclosure.

FIG. 3 is an elevational cross-sectional view of the inducer of FIG. 2.

FIG. 4 is an isometric end view of the of the leading end of the inducer of FIG. 2.

FIG. 5 is an isometric end view of the of the trailing end of the inducer of FIG. 2.

FIG. 6 is a cross-sectional view of an inducer guide vane according to an embodiment of the present disclosure.

FIG. 7 is an isometric view of a central portion of the inducer guide vane of FIG. 6.

### DETAILED DESCRIPTION

The illustrations presented herein are not meant to be actual views of any particular fluid exchanger or component thereof, but are merely idealized representations employed to describe illustrative embodiments. The drawings are not necessarily to scale. Elements common between figures may retain the same numerical designation.

As used herein, relational terms, such as “first,” “second,” “top,” “bottom,” etc., are generally used for clarity and convenience in understanding the disclosure and accompanying drawings and do not connote or depend on any specific preference, orientation, or order, except where the context clearly indicates otherwise.

As used herein, the term “and/or” means and includes any and all combinations of one or more of the associated listed items.

As used herein, the terms “vertical” and “lateral” refer to the orientations as depicted in the figures.

As used herein, the term “substantially” or “about” in reference to a given parameter means and includes to a degree that one skilled in the art would understand that the given parameter, property, or condition is met with a small degree of variance, such as within acceptable manufacturing tolerances. For example, a parameter that is substantially met may be at least 90% met, at least 95% met, at least 99% met, or even 100% met.

As used herein, the term “fluid” may mean and include fluids of any type and composition. Fluids may take a liquid form, a gaseous form, or combinations thereof, and, in some instances, may include some solid material. In some embodiments, fluids may convert between a liquid form and a gaseous form during a cooling or heating process as described herein. In some embodiments, the term fluid includes gases, liquids, and/or pumpable mixtures of liquids and solids.

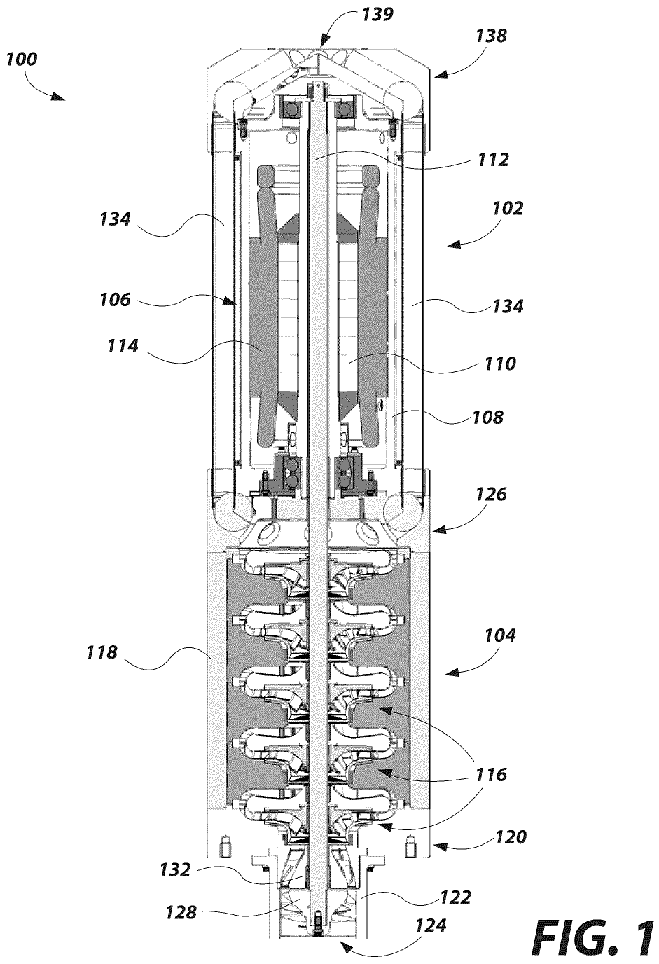

FIG. 1 is an elevational cross-sectional view of a modular submerged motor cryogenic pump 100, according to an embodiment of the present disclosure, comprising a motor module 102 and a hydraulic module 104. As the modular submerged motor cryogenic pump 100 may be operated in cryogenic conditions, the modular submerged motor cryogenic pump 100 may be provided with all of the components being suitable for operation within a working temperature range between about 75 K and about 200 K. Additionally, the modular submerged motor cryogenic pump 100 may be designed to provide leak-proof containment at working pressures between about 1 bar absolute pressure (barA) and about 160 barA.

The motor module 102 may include a motor 106 located within a motor housing 108. The motor 106 may include a rotor 110 (e.g., a permanent magnet rotor) that may be coupled to a drive shaft 112 and a stator 114 surrounding the rotor 110. In some embodiments the motor 106 may be a variable speed synchronous motor. In further embodiments, the motor may be configured to rotate relatively fast relative to convention motors, for example, the motor may be configured to rotate at about 2,000 rotations per minute (RPM) through 10,000 RPM, above 4,000 RPM, above 5,000 RPM, above 6,000 RPM, and/or above 7,000 RPM.

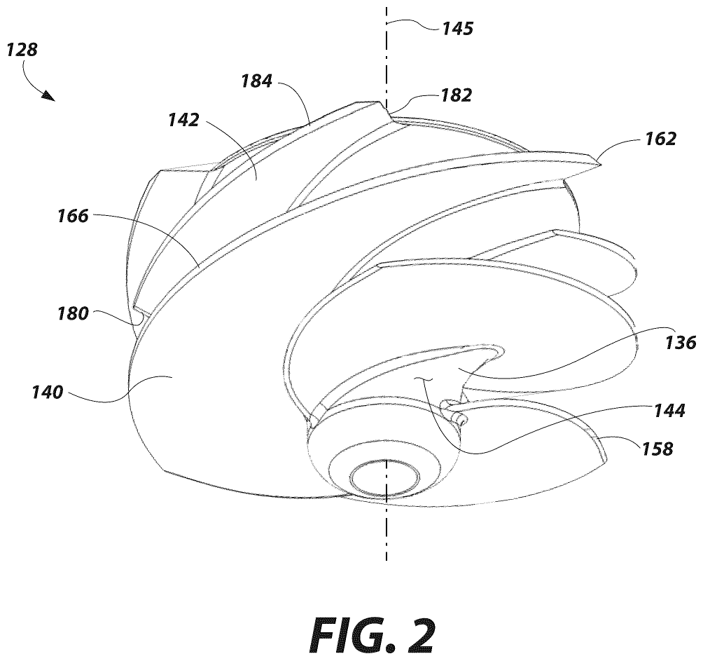

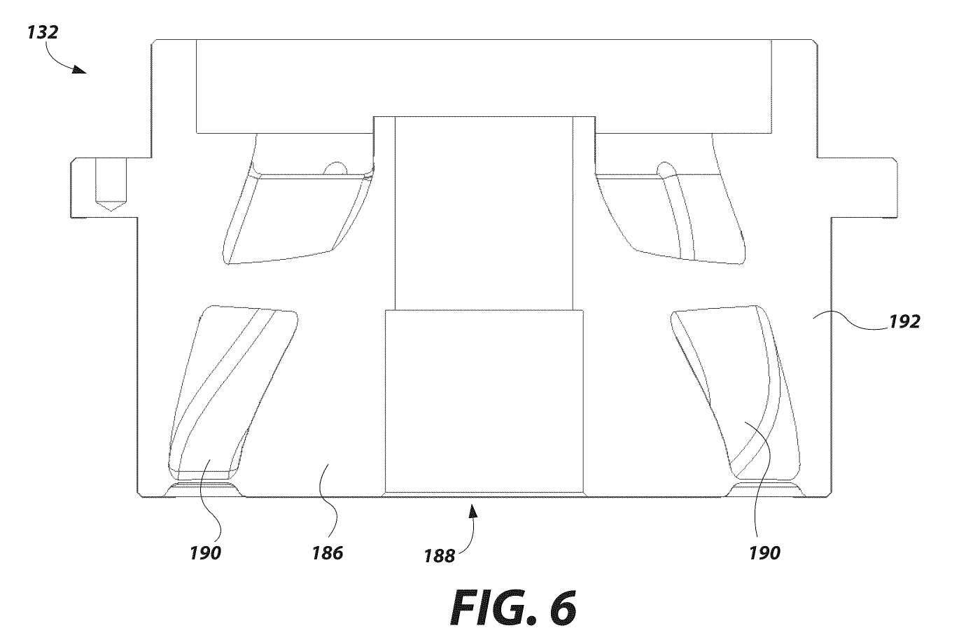

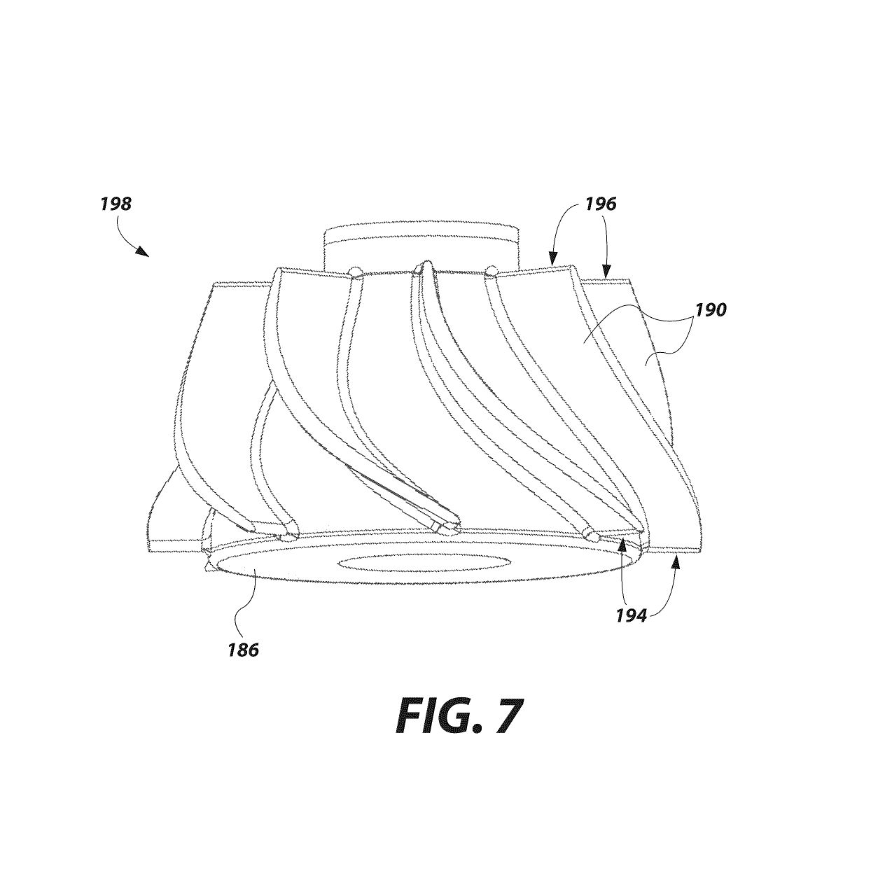

The hydraulic module 104 may include one or more centrifugal pump or pump stage 116 (e.g., five pump stages 116 as shown) located within a pump housing 118 and coupled to the drive shaft 112. The pump housing 118 may include an end plate 120 having a nozzle 122 defining a fluid inlet 124 to the modular submerged motor cryogenic pump 100 at a first end and a hydraulic manifold 126 at a second end. An inducer 128 (which will be discussed in greater detail herein with reference to FIGS. 2-5) may be located within the nozzle 122 between the fluid inlet 124 and a first pump stage 116 and connected to an end of the drive shaft 112. For example, the inducer 128 may be coupled to the drive shaft 112 via one or more of an interference fit (e.g., a friction fit or a close bore fit), interlocking splines, a keyed coupling (e.g., a key, a keyseat, and a keyway), a collet, and/or a fastener (e.g., a nut, a bolt, and/or a retaining ring). Additionally, an inducer guide vane 132 (which will be discussed in greater detail herein with reference to FIGS. 6 and 7) may be located between the inducer 128 and the first pump stage 116, which may be utilized to recover velocity energy in the fluid exiting the inducer to further increase fluid pressure (i.e., head) at the inlet to the first pump stage 116.

The motor module 102 may be coupled to the hydraulic module 104 and fluid channels (e.g., pipes 134) may be positioned to direct fluid form the hydraulic manifold 126 of the hydraulic module 104 to a hydraulic manifold 138 located at a top end of the motor module 102. The hydraulic manifold 138 may include a fluid outlet 139 for directing fluid out of the modular submerged motor cryogenic pump 100. Additionally, internal fluid channels may direct a portion of the pumped fluid from the hydraulic module 104 into the motor module 102 to regulate the temperature of components therein during operation, such as the motor 106 and bearings.

While FIG. 1 shows a submerged motor cryogenic pump, in other embodiments, inducers according to the disclosure may be utilized on other pumps or fluid handling devices.

FIG. 2 is an isometric view of the inducer 128 that may be used with the modular submerged motor cryogenic pump 100 of FIG. 1. The inducer may include a hub 136, and main blades 140 and splitter blades 142 extending radially (relative to an axis of rotation 145) from an outer lateral surface 144 of the hub 136. For example, the inducer 128 may include three main blades 140 and three splitter blades 142.

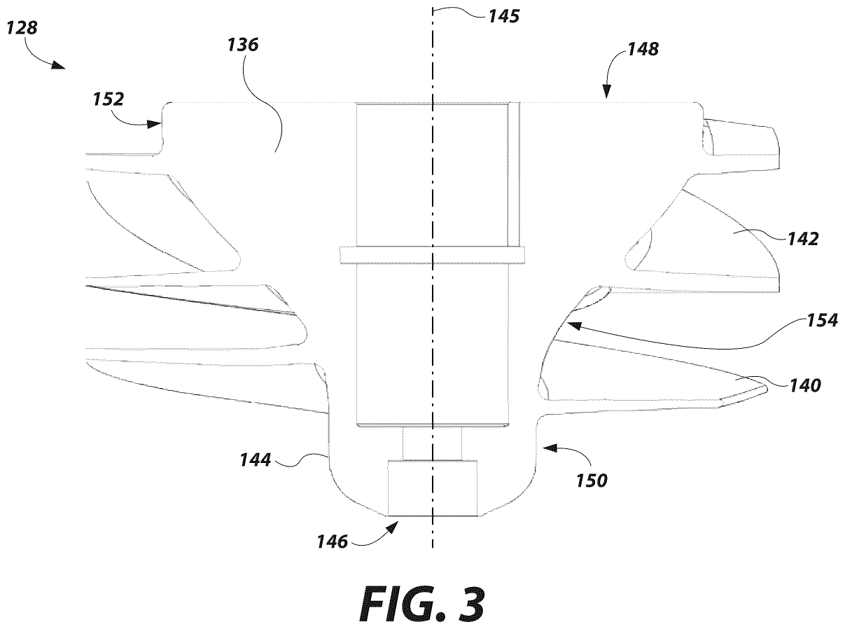

FIG. 3 is an elevational cross-sectional view of the inducer 128 of FIG. 2. As shown in FIG. 3, the outer lateral surface 144 of the hub 136 may extend from a leading end 146 to a trailing end 148 of the inducer 128. The outer lateral surface 144 of the hub 136 may have a leading surface section 150 adjacent the leading end 146 having a first substantially cylindrical shape and a trailing surface section 152 adjacent the trailing end 148 having a second substantially cylindrical shape. Additionally, the outer lateral surface 144 of the hub 136 may have an intermediate surface section 154 located between the leading surface section 150 and the trailing surface section 152 having a frustoconical shape. For example, the width (e.g., diameter) of the hub 136 may gradually increase between the leading surface section 150 and the trailing surface section 152.

The trailing surface section 152 of the hub 136 may have an outer diameter that is significantly larger than an outer diameter of the leading surface section 150. In some embodiments, the diameter of the trailing surface section 152 of the hub 136 may be at least about 75% of the outer diameter of the inducer 128. For example, the diameter of the trailing surface section 152 of the hub 136 may be at about 78% of the outer diameter of the inducer 128. Whereas an outer diameter of the leading surface section 150 of the hub 136 may be less than about 33% of the outer diameter of the inducer 128. For example the diameter of the leading surface section 150 of the hub 136 may be about 30% of the outer diameter of the inducer 128.

The leading surface section 150 of the hub 136 may extend along at least 5%, at least 6%, at least 7%, at least 8%, and/or at least 9% of the axial length (i.e., from the leading end 146 to the trailing end 148) of the hub 136. For example, the leading surface section 150 of the hub 136 may extend along about 10% of the axial length of the hub 136. Similarly, the trailing surface section 152 of the hub 136 may extend along at least 5%, at least 6%, at least 7%, at least 8%, and/or at least 9% of the axial length of the hub 136. For example, the leading surface section 150 of the hub 136 may extend along about 10% of the axial length of the hub 136.

Transitions between surface sections of the outer lateral surface 144 of the hub 136 may be filleted. For example, a first fillet may be located between leading end 146 and the leading surface section 150, a second fillet may be located between the leading surface section 150 and the intermediate surface section 154, a third fillet may be located between the intermediate surface section 154 and the trailing surface section 152, and a fourth fillet may be located between the trailing surface section 152 and the trailing end 148.

The main blades 140 may extend radially from the outer lateral surface 144 of the hub 136 toward or to an outer diameter of the inducer 128. The outer diameter of the inducer 128 may be sized to correspond to an inner diameter of the nozzle 122 of the pump housing 118, such that the outer diameter of the inducer 128 sits adjacent the inner diameter of the nozzle 122 with a relatively small clearance therebetween. The main blades 140 may additionally extend circumferentially along a first helical path over the leading surface section 150, the intermediate surface section 154, and the trailing surface section 152 of the outer lateral surface 144 of the hub 136.

Unlike a typical screw (i.e., an Archimedes screw) that may have one or more blades or threads following a helical path with a constant helix angle, the helix angle of the first helical path of the inducer 128 may not be constant and may change. For example, the first helical path may have an increasing helix angle from the leading surface section 150 to the trailing surface section 152 defining a main blade angle. Accordingly, the spacing between the main blades 140 may increase from the leading surface section 150 to the trailing surface section 152 and the blade angle of the main blades 140 may become larger (e.g., steeper) as the main blades 140 extend from the leading surface section 150 to the trailing surface section 152. In some embodiments, the helix angle along the first helical path may increase (e.g., increase linearly) as the main blades 140 extends from a leading edge 158 of the main blade 140 to a trailing edge 162 of the main blade 140 (see FIG. 2).

For example, referring again to FIG. 2, the main blade angle (i.e., the angle of the main blade 140 measured in a tangential direction relative to a reference plane oriented perpendicular to the axis of rotation of the inducer 128) of one or more of the main blades 140 at the leading edge 158 location at the outer lateral surface 144 of the hub 136 may be oriented at a first angle and the main blade angle of one or more of the main blades 140 may increase (e.g., gradually increase) as the main blade 140 extends to the trailing edge 162 location at the outer lateral surface 144 of the hub 136.

In some embodiments, the main blade angle of one or more of the main blades 140 at the leading edge 158 location at the outer lateral surface 144 of the hub 136 may be less than about 27 degrees, less than about 26 degrees, and/or less than about 25 degrees. In some embodiments, the main blade angle of one or more of the main blades 140 at the leading edge 158 location at the outer lateral surface 144 of the hub 136 may be between about 22.5 degrees and about 26.5 degrees, between about 23 degrees and about 26 degrees, between about 23.5 degrees and about 25.5 degrees, and/or between about 24 degrees and about 25 degrees.

In some embodiments, the main blade angle of one or more of the main blades 140 at the trailing edge 162 location at the outer lateral surface 144 of the hub 136 may be greater than about 27 degrees, greater than about 28 degrees, and/or greater than about 29 degrees. In some embodiments, the main blade angle of one or more of the main blades 140 at the trailing edge 162 location at the outer lateral surface 144 of the hub 136 may be between about 26 degrees and about 30 degrees, between about 26.5 degrees and about 29.5 degrees, between about 29 degrees and about 27 degrees, and/or between about 28 degrees and about 27.5 degrees.

For example, in some embodiments the helix angle of the first helical path (i.e., the main blade angle) may begin at about 24.6 degrees at the leading edge 158 and the helix angle may increase linearly along the first helical path to end at about 27.8 degrees at the trailing edge 162.

Each of the main blades 140 may include an arcuate outer lateral surface 166 that may be positioned proximate a shroud (e.g., the nozzle 122 shown in FIG. 1). The arcuate outer lateral surface 166 may define the outer diameter of the inducer 128 (e.g., an outermost diameter of the inducer 128). The arcuate outer lateral surface 166 of one or more of the main blades 140 may have a wrap angle (i.e., circumferential extent about the hub 136) greater than 150 degrees, and each of the main blades 140 may have a wrap angle of greater than 180 degrees at midspan (i.e., a span extending tangentially along the radial middle). In some embodiments, the arcuate outer lateral surface 166 of one or more of the main blades 140 may have a wrap angle (i.e., circumferential extent about the hub 136) of about 180 degrees, and each of the main blades 140 may have a wrap angle of about 217 degrees at midspan (i.e., a span extending tangentially along the radial middle).

The main blade angle of one or more of the main blades 140 at the outer diameter of the inducer 128 (i.e., at the arcuate outer lateral surface 166) may be smaller than the main blade angle at the outer lateral surface 144 of the hub 130 corresponding to the same axial location. That is, the main blade angle may gradually decrease as the main blade 140 extends radially outward from the hub 130 to the arcuate outer lateral surface 166.

As above, the main blade angle of one or more of the main blades 140 may also change (e.g., gradually increase) between the leading edge 158 and the trailing edge 162 at the outer diameter of the inducer 128 (i.e., at the arcuate outer lateral surface 166). That is, the main blade angle may gradually increase as the main blade 140 extends axially along the outer diameter of the inducer 128 (i.e., at the arcuate outer lateral surface 166) between an inlet or the leading edge 158 and an outlet or the trailing edge 162.

In some embodiments, the main blade angle of one or more of the main blades 140 at the leading edge 158 location at the outer diameter of the inducer 128 (i.e., at the arcuate outer lateral surface 166) may be less than about 11 degrees, less than about 10 degrees, and/or less than about 9 degrees. In some embodiments, the main blade angle of one or more of the main blades 140 at the leading edge 158 location at the outer diameter of the inducer 128 (i.e., at the arcuate outer lateral surface 166) may be between about 6 degrees and about 10 degrees, between about 7 degrees and about 9 degrees, and/or between about 7.5 degrees and about 8.5 degrees.

In some embodiments, the main blade angle of one or more of the main blades 140 at the trailing edge 162 location at the outer diameter of the inducer 128 (i.e., at the arcuate outer lateral surface 166) may be greater than about 18 degrees, greater than about 19 degrees, and/or greater than about 20 degrees. In some embodiments, the main blade angle of one or more of the main blades 140 at the trailing edge 162 location at the outer diameter of the inducer 128 (i.e., at the arcuate outer lateral surface 166) mat be between about 18 degrees and about 22 degrees, between about 19 degrees and about 21.5 degrees, and/or between about 19.5 degrees and about 20 degrees.

For example, the main blade angle of one or more of the main blades 140 at the leading edge 158 location at the outer diameter of the inducer 128 (i.e., at the arcuate outer lateral surface 166) may be less than about 8.5 degrees, and the main blade angle of one or more of the main blades 140 at the trailing edge 162 location at the outer diameter of the inducer 128 may be greater than about 20 degrees. In some embodiments, the main blade angle of one or more of the main blades 140 at the leading edge 158 location at the outer diameter of the inducer 128 (i.e., at the arcuate outer lateral surface 166) may be about 8 degrees, and the main blade angle of one or more of the main blades 140 at the trailing edge 162 location at the outer diameter of the inducer 128 may be greater than about 20.5 degrees.

The main blades 140 may be tapered proximate the leading end 146 of the inducer 128, but a majority of one or more of the main blades 140 may have a substantially constant thickness. The tapering of the main blades 140 at the leading end 146 may be provided by shaping only, or primarily, on the low-pressure side (i.e., the side facing the leading end 146 of the inducer 128) of the leading end of the main blades 140.

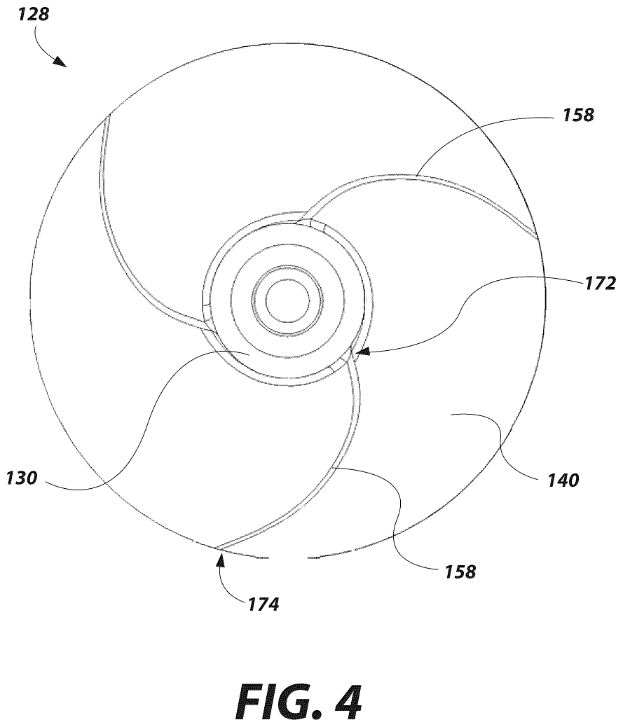

FIG. 4 is an isometric end view of the of the leading end 146 of the inducer 128 of FIG. 2. As may be seen in FIG. 4, each of the main blades 140 may have a swept leading edge 158 defined by a gradually increasing radial blade length from a leading tip 172 of the leading edge 158, located at the leading surface section 150 (see FIG. 3) of the hub 136 where the leading edge 158 meets with the hub 136, to a trailing end 174 of the leading edge 158, located at the outer diameter of the inducer 128 where the leading edge 158 meets with the arcuate outer lateral surface 166 (see FIG. 2). In other words, rather than just extending in a straight radial line from the hub to the outer diameter of the inducer at the leading tip 172, the main blades 140 extend out gradually in a radial direction from the leading tip 172 to the trailing end 174 to define the swept leading edge 158 so that the leading edge 158 may not define a relatively sharp corner that sticks out radially at the leading end of the main blades 140, but sweeps back over a circumferential distance. The swept leading edge 158 may have a wrap angle that is greater than about 40 degrees. In some embodiments, the swept leading edge 158 may have a wrap angle that is greater than about 50 degrees. In further embodiments, the swept leading edge 158 may have a wrap angle that is greater than about 60 degrees. Additionally, the leading edge 158 of one or more of the main blades 140 may be a curved, bullnose edge, and the trailing edge 162 (see FIG. 2) may be a relatively sharp, beveled edge.

Referring again to FIGS. 2 and 3, the splitter blades 142 may extend radially from the outer lateral surface 144 of the hub 136 to an outer diameter of the inducer 128 and extend circumferentially along a second helical path starting on the intermediate surface section 154 and extending over the intermediate surface section 154 and the trailing surface section 152 of the outer lateral surface 144 of the hub 136. The second helical path may have an increasing helix angle from the intermediate surface section 154 to the trailing surface section 152 defining a splitter blade angle. Each of the splitter blades 142 may be located circumferentially about the hub 130 between two of the main blades 140, respectively. In some embodiments, the helix angle along the second helical path may increase (e.g., increase linearly) from a leading edge 180 of the splitter blades 142 to a trailing edge 182 of the splitter blades 142.

The positioning of the splitter blades 142 between respective main blades 140 may change as the splitter blades 142 extend between the leading edge 180 and the trailing edge 182. For example, the leading edge 180 of one or more of the splitter blades 142 may be positioned relatively closer (e.g., at least about 30% closer) to a circumferentially trailing main blade 140 than a circumferentially leading main blade 140. Additionally, the trailing edge 182 of one or more of the splitter blades 142 may be located about equal distance from a circumferentially trailing main blade 140 and a circumferentially leading main blade 140.

Like the main blades 140, the splitter blades 142 may each include an arcuate outer lateral surface 184 having substantially the same diameter as the arcuate outer lateral surface 166 of one or more of the main blades 140 defining the outer diameter of the inducer 128. Also like the main blades 140, the leading edge 180 of one or more of the splitter blades 142 may be a curved, bullnose edge, and the trailing edge 182 may be a relatively sharp, beveled edge. The leading edge 180 of the splitter blades 142 may also be swept but may be swept over a smaller wrap angle relative to the leading end 146 of the main blades 140. For example, the leading edge 180 of the splitter blades 142 may have a wrap angle that is less than about 40 degrees. Additionally, the blade angle at each location of one or more of the splitter blades 142 at the outer diameter of the inducer 128 (i.e., at the arcuate outer lateral surface 184) may be smaller than the blade angle at the outer lateral surface 144 of the hub 130 corresponding to the same axial location.

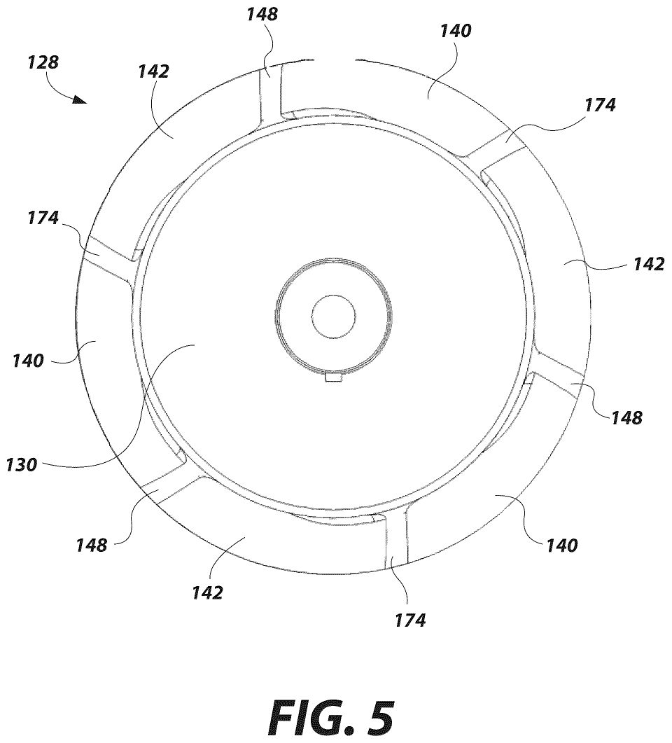

FIG. 5 is an isometric end view of the of the trailing end of the inducer 128 of FIG. 2. As shown, the trailing ends 148 of the main blades 140 and trailing ends 174 of the splitter blades 142 may be evenly spaced about the circumference of the hub 130 at the trailing end of the inducer 128. Accordingly, the trailing ends 148 of the main blades 140 may be evenly spaced from each other and may each also be spaced evenly from each of the adjacent trailing ends 174 of the splitter blades 142.

In some embodiments, the inducer 128 may be machined from a solid billet of material, such as bronze, brass, steel, or aluminum, such as with a computer numerical control (CNC) mill and/or lathe. In further embodiments, the inducer 128 may be machined from multiple solid billets of material, such as bronze, brass, steel, and/or aluminum, such as with a computer numerical control (CNC) mill and/or lathe, and assembled, such as by brazing and/or welding. In yet further embodiments, the inducer 128 may be cast from a molten material, such as bronze, brass, steel, or aluminum, such as by investment casting, or sand casting.

FIG. 6 is a cross-sectional view of the inducer guide vane 132 of the modular submerged motor cryogenic pump 100 according to an embodiment of the present disclosure. The inducer guide vane 132 may be located between the inducer 128 and the first pump stage 116 (see FIG. 1). The inducer guide vane 132 may include a hub 186 having a central aperture 188 to allow passage of the drive shaft 112 therethrough and a plurality of vanes 190 extending from the hub 186. Additionally, the inducer guide vane 132 may include an outer annular guide 192 surrounding the hub 186 and the plurality of vanes 190, and the plurality of vanes 190 may extend from the hub 186 to the outer annular guide 192 forming a plurality of fluid channels therebetween. The outer annular guide 192 may have an annular tapered inner surface having a diameter at the leading end that is larger than a diameter at the trailing end.

FIG. 7 is an isometric view of a central portion 198 of the inducer guide vane 132 showing the hub 186 and plurality of vanes 190 without showing the surrounding outer annular guide 192 (see FIG. 6). The outer diameter of the leading end of the hub 186 of the inducer guide vane 132 may be similarly sized as the outer diameter of the trailing end of the hub 130 of the inducer 128, and the outer diameter of the trailing end of the hub 186 may be smaller than the outer diameter of the leading end of the hub 186.

The plurality of vanes 190 of the inducer guide vane 132 may extend along a helical path on an outer lateral surface of the hub 186, which may extend in the opposite circumferential direction relative to the helical path of the main blades 140 of the inducer 128. The helical path may have an increasing helix angle from the leading end to the trailing end of the plurality of vanes 190 defining a vane angle. In some embodiments, the helix angle along the helical path may increase linearly from a leading edge 194 of one or more of the plurality of vanes 190 to a trailing edge 196 of one or more of the plurality of vanes 190.

In some embodiments, the vane angle (i.e., the angle of the vane 190 measured in a tangential direction relative to a reference plane oriented perpendicular to the axis of rotation of the drive shaft 112 within the inducer guide vane 132) of one or more of the plurality of vanes 190 may increase between the leading edge 194 and the trailing edge 196. In some embodiments, the vane angle of one or more of the plurality of vanes 190 may increase between the hub 186 and a radially outward location proximate the outer annular guide 192.

In some embodiments, the vane angle of one or more of vanes 190 at the leading edge 194 location at the hub 186 may be between about 36 degrees and about 40 degrees, between about 37 degrees and about 39 degrees, and/or between about 37.5 degrees and about 38.5 degrees and the vane angle of one or more of the plurality of vanes 190 at the trailing edge 196 location at the hub 186 may be between about 85 degrees and about 95 degrees, between about 88 degrees and about 92 degrees, and/or between about 89 degrees and about 91 degrees. For example, the vane angle may begin at about 38 degrees at the leading edge 194 location at the hub 186 and the vane angle may increase (e.g., increase linearly) along the helical path to end at about 90 degrees at the trailing edge 196 location at the hub 186.

In some embodiments, the vane angle of one or more of vanes 190 at the leading edge 194 location at the outer annular guide 192 may be between about 27 degrees and about 33 degrees, between about 28 degrees and about 32 degrees, and/or between about 29 degrees and about 31 degrees and the vane angle of one or more of the plurality of vanes 190 at the trailing edge 196 location at the outer annular guide 192 may be between about 85 degrees and about 95 degrees, between about 88 degrees and about 92 degrees, and/or between about 89 degrees and about 91 degrees. For example, the vane angle may begin at about 30.5 degrees at the leading edge 194 location at the outer annular guide 192 and the vane angle may increase linearly along the helical path to end at about 90 degrees at the trailing edge 196 location at the outer annular guide 192.

In some embodiments, one or more of the plurality of vanes 190 may have a wrap angle (i.e., circumferential extent) of about 51 degrees. The vane angle at each location of one or more of the plurality of vanes 190 at the outer annular guide 192 may be smaller than the vane angle at the hub 186 corresponding to the same axial location at the leading end of the inducer guide vane 132 and the vane angle of one or more of the plurality of vanes 190 at the trailing end may be substantially the same at the hub 186 as at the outer annular guide 192.

In some embodiments, the inducer guide vane 132 may be machined from a solid billet of material, such as bronze, brass, steel, or aluminum, such as with a computer numerical control (CNC) mill and/or lathe. In further embodiments, the inducer guide vane 132 may be machined from multiple solid billets of material, such as bronze, brass, steel, and/or aluminum, such as with a computer numerical control (CNC) mill and/or lathe, and assembled, such as by brazing and/or welding. In yet further embodiments, the inducer guide vane 132 may be cast from a molten material, such as bronze, brass, steel, or aluminum, such as by investment casting, or sand casting.

In view of the foregoing, referring again to FIG. 1, the modular submerged motor cryogenic pump 100 may be manufactured by coupling an appropriately sized motor module 102 to an appropriately sized hydraulic module 104, and the inducer 128. The motor 106 of the motor module 102 and the pump stages 116 of the hydraulic module 104 may be coupled to the drive shaft 112, such that the motor 106 may power the pump stages 116. The inducer 128 may be coupled to the end of the drive shaft 112, such that the inducer 128 may also be rotated by the motor 106. Additionally, an inducer guide vane 132 may be positioned between the inducer 128 and the first pump stage 116 with the drive shaft 112 extending through the central aperture 188 of the inducer guide vane 132.

In operation, the modular submerged motor cryogenic pump 100 may located in a cryogenic fluid tank (not shown) and submerged in cryogenic fluid with the fluid inlet 124 located proximate to the bottom of the cryogenic fluid tank. Electrical power may be provide to the motor 106 which may cause the stator 114 to rotate, which may cause the drive shaft 112 coupled to the stator 114 to rotate. The drive shaft 112 may rotate the pump stages 116 and the inducer 128 to initiate pumping of the cryogenic fluid by the modular submerged motor cryogenic pump 100.

If the motor 106 is provided significant electric power on startup (e.g., if the motor 106 is connected directly to line power) the rotation of the stator 114 may accelerate relatively quickly, thus causing the pump stages 116 and the inducer 128 to accelerate relatively quickly. The quick acceleration of the inducer 128 and the inertia of the fluid may create significant forces on the inducer 128, especially on the leading edges 158 of the main blades 140. The swept nature of the leading edges 158, however, may reduce and/or more effectively distribute the forces acting on the leading edges 158 and/or may provide sufficient structural support of the main blades 140 at the leading edges 158 to prevent fracturing and/or failure of the main blades 140 in situations wherein inducers having blades without such swept leading edges may fracture and/or fail.

In some embodiments, the motor 106 may be a variable speed synchronous motor driven with a variable frequency drive. Accordingly, the rotational acceleration of the motor 106 may be controlled and slowed at startup to further reduce the potential of fracturing and/or failure of the main blades 140 during startup of the modular submerged motor cryogenic pump 100.

The rotation of the inducer 128 may draw fluid into the modular submerged motor cryogenic pump 100 and may compress and accelerate the fluid and direct the fluid into the inducer guide vane 132 to provide the fluid to the first pump stage 116 at an elevated pressure, which may prevent and/or reduce vaporization and/or cavitation within the first pump stage 116. Furthermore, the significant increase in the diameter of the trailing surface section 152 of the hub 136 relative to the diameter of the leading surface section 150 may significantly reduce the size of a channel formed between the main blades 140 and a surrounding shroud as the fluid travels from the leading end 146 to the trailing end 148 of the hub 136. This significant reduction in the fluid channel size may significantly increase the velocity and/or the pressure of the fluid as it passes therethrough. Furthermore, the shape of the main blades 140 and the splitter blades 142, such as the increasing blade angle from leading edge 158 to trailing edge 162 and the blade angle at the hub 136 relative to the blade angle at the arcuate outer lateral surface 166, may significantly accelerate and/or pressurize the fluid through pressure difference created between the top and the bottom of the main blades 140 and the splitter blades 142 and by centrifugal forces.

The fluid exiting the inducer 128 may be directed into the inducer guide vane 132. The fluid exiting the inducer 128 may have a significant tangential velocity as it enters the inducer guide vane 132. The plurality of vanes 190 of the inducer guide vane 132 may redirect the fluid flow and change the direction of the tangential component of the fluid flow to direct the flow in a generally axial direction. Accordingly, the inducer guide vane 132 may convert the tangential velocity of the fluid flow into head (i.e., pressure) and may additionally compress the fluid after it exits the inducer 128 and prior to the fluid entering the first pump stage 116.

The pump stages 116 may pump the fluid therethrough increasing the pressure and/or velocity of the fluid in each pump stage 116. The fluid may then be directed into the hydraulic manifold 126, through the pipes 134, into the hydraulic manifold 138, and out of the modular submerged motor cryogenic pump 100 via the fluid outlet 139. A portion of the fluid may flow into the motor module 102 and cool components such as the motor 106.

In operation, the inducer 128 may perform significantly better than previous inducers. In some embodiments, the inducer 128 may have a suction specific speed over 100,000, over 200,000, and/or over 300,000. In some embodiments, the inducer 128 with the inducer guide vane 132 may provide over 100 feet of head production, over 125 feet of head production, and/or over 140 feet of head production at the inlet of the first pump stage 116. For example, the inducer 128 may provide about 150 feet of head production at the inlet of the first pump stage 116 through the inducer guide vane 132. Additionally, the inducer 128 may provide significant subcooling and may provide over 3 degrees Kelvin subcooling, over 4 degrees Kelvin subcooling, and/or over 5 degrees Kelvin subcooling at the inlet of the first pump stage 116 through the inducer guide vane 132. For example, the inducer 128 may provide about 6 degrees Kelvin subcooling at the inlet of the first pump stage 116 through the inducer guide vane 132. Accordingly, the inducer 128 may be able to recondense and deliver fluid having a significant vapor fraction at the fluid inlet 124 of the modular submerged motor cryogenic pump 100 to the inlet of the first pump stage 116 in a subcooled liquid state through the inducer guide vane 132. For example, the inducer 128 may be able to recondense and deliver fluid having a vapor fraction over 10%, over 15%, over 18%, and/or over 20% at the fluid inlet 124 of the modular submerged motor cryogenic pump 100 to the inlet of the first pump stage 116 in a subcooled liquid state through the inducer guide vane 132. In view of the foregoing, the inducer 128 may also enable the modular submerged motor cryogenic pump 100 of be capable of removing a significantly greater amount of fluid from a tank than existing pumps, which may increase the productivity and/or profitability of a facility.

For example, the inducer 128 may direct fluid into the inducer guide vane 132 to provide fluid to the first pump stage 116 of the cryogenic pump 100 at a pressure greater than about 100 feet of head higher than at the fluid inlet 124 and with greater than 3 degrees Kelvin subcooling relative to the fluid temperature at the fluid inlet 124. For another example, the inducer 128 may direct fluid into the inducer guide vane 132 to provide fluid to the first pump stage 116 of the cryogenic pump 100 at a pressure greater than about 125 feet of head higher than at the fluid inlet 124 and with greater than 4 degrees Kelvin subcooling relative to the fluid temperature at the fluid inlet 124. For yet another example, the inducer 128 may direct fluid into the inducer guide vane 132 to provide fluid to the first pump stage 116 of the cryogenic pump 100 at a pressure greater than about 140 feet of head higher than at the fluid inlet 124 and with greater than 5 degrees Kelvin subcooling relative to the fluid temperature at the fluid inlet 124.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment while still being encompassed within the scope of the disclosure as contemplated by the inventors.

What is claimed is:

1. An inducer for a cryogenic pump, the inducer comprising:
a hub having an outer lateral surface extending from a leading end to a trailing end, the outer lateral surface having a leading surface section having a first cylindrical shape, an intermediate surface section having a frustoconical shape, and a trailing surface section having a second cylindrical shape;
main blades extending radially from the outer lateral surface of the hub toward an outer diameter of the inducer and extending circumferentially along a first helical path over the leading surface section, the intermediate surface section, and the trailing surface section, the first helical path having an increasing helix angle from the leading surface section to the trailing surface section defining a main blade angle of the main blades; and
splitter blades extending radially from the outer lateral surface of the hub toward the outer diameter of the inducer and extending circumferentially along a second helical path over at least the intermediate surface section and the trailing surface section of the outer lateral surface of the hub, the second helical path having an increasing helix angle from the leading surface section to the trailing surface section defining a splitter blade angle of the splitter blades, each of the splitter blades located between two of the main blades, respectively.

2. The inducer of claim 1, wherein a diameter of the trailing surface section of the hub is at least about 75% of the outer diameter of the inducer.

3. The inducer of claim 2, wherein the diameter of the trailing surface section of the hub is about 78% of the outer diameter of the inducer.

4. The inducer of claim 2, wherein a diameter of the leading surface section of the hub is less than about 33% of the outer diameter of the inducer.

5. The inducer of claim 4, wherein the diameter of the leading surface section of the hub is about 30% of the outer diameter of the inducer.

6. The inducer of claim 1, wherein each of the main blades have a swept leading edge defined by a gradually increasing radial blade length over a sweep angle of at least 40 degrees from a leading tip, located at the leading surface section of the hub, to a trailing end, located at the outer diameter of the inducer.

7. The inducer of claim 1, wherein a leading edge of each splitter blade is positioned relatively closer to a circumferentially trailing main blade than a circumferentially leading main blade.

8. The inducer of claim 1, wherein the leading surface section of the hub is greater than 5% of an axial length of the inducer and the trailing surface section of the hub is greater than 5% of the axial length of the inducer.

9. The inducer of claim 1, wherein each of the main blades and each of the splitter blades comprise an arcuate outer lateral surface defining the outer diameter of the inducer.

10. The inducer of claim 9, wherein the arcuate outer lateral surface of one or more of the main blades has a wrap angle of about 180 degrees.

11. The inducer of claim 1, wherein the main blade angle of one or more of the main blades at the outer diameter of the inducer is smaller than the main blade angle at the outer lateral surface of the hub corresponding to a same axial location.

12. The inducer of claim 11, wherein the main blade angle of one or more of the main blades at a leading edge location at the outer lateral surface of the hub is less than about 25 degrees.

13. The inducer of claim 12, wherein the main blade angle of one or more of the main blades at a trailing edge location at the outer lateral surface of the hub is greater than about 27 degrees.

14. The inducer of claim 13, wherein the main blade angle of one or more of the main blades at the leading edge location at the outer diameter of the inducer is less than about 8.5 degrees.

15. The inducer of claim 14, wherein the main blade angle of one or more of the main blades at the trailing edge location at the outer diameter of the inducer is greater than about 20 degrees.

16. A pump for pumping a cryogenic fluid, the pump comprising:
a fluid inlet and a fluid outlet;
a motor;
a pump stage;
an inducer located between the fluid inlet and the pump stage, the inducer comprising:
a hub having an outer lateral surface extending from a leading end to a trailing end, the outer lateral surface having a leading surface section having a first cylindrical shape, an intermediate surface section having a frustoconical shape, and a trailing surface section having a second cylindrical shape;
main blades extending radially from the outer lateral surface of the hub to an outer diameter of the inducer and extending circumferentially along a first helical path from the leading surface section to the trailing surface section, the main blades having an increasing helix angle from the leading surface section to the trailing surface section; and
splitter blades extending radially from the outer lateral surface of the hub to the outer diameter of the inducer and extending circumferentially along a second helical path from the intermediate surface section to the trailing surface section of the outer lateral surface of the hub, the splitter blades having an increasing helix angle from the leading surface section to the trailing surface section; and
a drive shaft coupling the motor to the pump stage and the inducer.

17. The pump of claim 16, further comprising an inducer guide vane located between the inducer and the pump stage.

18. A method of inducing flow into a cryogenic pump, the method comprising rotating an inducer to draw fluid through a fluid inlet with the inducer and direct the fluid into an inducer guide vane to provide fluid to a first pump stage of the cryogenic pump at a pressure greater than about 100 feet of head higher than at the fluid inlet and with greater than 3 degrees Kelvin subcooling relative to a fluid temperature at the fluid inlet.

19. The method of claim 18, further comprising providing fluid to the first pump stage of the cryogenic pump at a pressure greater than about 140 feet of head higher than at the fluid inlet and with greater than 5 degrees Kelvin subcooling relative to the fluid temperature at the fluid inlet.

20. The method of claim 18, further comprising recondensing fluid having a vapor fraction over 18% at the fluid inlet and delivering the fluid in a subcooled liquid state to the first pump stage.
